(19) United States
(12) Patent Application Publication
(10) Pub. No.: US 2026/0296983 A1
(43) Pub. Date: Oct. 1, 2026

(54) SELF-ASSEMBLED SOFT MAGNETIC FERRITE NANOCOMPOSITE MATERIALS AND PASSIVE COMPONENTS AND METHODS OF MAKING SAME

(71) Applicant: UNIVERSITY OF PITTSBURGH- OF THE COMMONWEALTH SYSTEM OF HIGHER EDUCATION, PITTSBURGH, PA (US)

(72) Inventors: PAUL R. Ohodnicki, Allison Park, PA (US); Suraj Venkateshwaran Mullurkara, Pittsburgh, PA (US)

(73) Assignee: UNIVERSITY OF PITTSBURGH -OF THE COMMONWEALTH SYSTEM OF HIGHER EDUCATION, PITTSBURGH, PA (US)

(21) Appl. No.: 19/489,106

(22) PCT Filed: Aug. 12, 2024
(86) PCT No.: PCT/US2024/041904

§ 371 Date: Dec. 1, 2025

Related U.S. Application Data
(60) Provisional application No. 63/519,018, filed on Aug. 11, 2023.

(51) Int. Cl. C04B 41/51; C04B 35/26; C04B 35/626; C04B 35/64; C04B 41/45; H01F 1/34

(52) U.S. Cl. CPC C04B 41/5144; C04B 35/265; C04B 35/6261; C04B 35/6264; C04B 35/62655; C04B 35/64; C04B 41/4529; C04B 41/4556; H01F 1/344; C04B 2235/3274; C04B 2235/405; C04B 2235/443; C04B 2235/6582

(57) ABSTRACT

Methods of making nanocomposite materials and nanocomposite passive components includes obtaining a base ferrite material, and reducing a material including the base ferrite material to selectively precipitate out ferromagnetic metal ions to produce a reduced material, wherein the reduced material includes a ferrite matrix having a plurality of ferrite grains and a plurality of metal nanoparticles on a surface of and/or embedded within each of the ferrite grains. Also, methods of making nanocomposite materials and nanocomposite passive components includes obtaining a. base ferrite material, creating a mixture including the base ferrite material and a plurality of metal nanoparticles, and thermally processing the mixture or a component formed using the mixture to produce the nanocomposite material/component, wherein the nanocomposite material/component includes a ferrite matrix having a plurality of ferrite grains and the plurality of metal nanoparticles on a surface of and/or embedded within each of the ferrite grains.

### CROSS REFERENCE TO RELATED APPLICATIONS

This application claims priority to U.S. Provisional Patent Application Ser. No. 63/519,018, filed on Aug. 11, 2023 and titled “Self-Assembled Nanocomposite Soft Magnetic Ferrites,” the disclosure of which is incorporated herein by reference.

### STATEMENT OF GOVERNMENT INTEREST

This invention was made with government support under grant #N00014-21-1-2498 awarded by the Office of Naval Research (ONR). The government has certain rights in the invention.

### FIELD OF THE INVENTION

The disclosed concept relates generally to soft magnetic materials (SMMs), and, in particular, to self-assembled soft magnetic ferrite nanocomposite materials and passive components, such as, without limitation, toroidal cores, for use in electromagnetic applications, such as, without limitation, power electronics and microwave applications, and method of manufacturing such nanocomposite materials and passive components.

### BACKGROUND OF THE INVENTION

Soft magnetic materials (SMMs) are a class of ferromagnetic materials which are characterized by high permeabilities and low coercivities, These properties make them suitable for power magnetic applications such as transformers, motors and inductors where a field is cycled repeatedly due to the application of an alternating current (AC). Commonly used soft magnetic materials include Si steels, bulk crystalline alloys, alloys, nanocrystalline alloys and ferrites. Among these materials, Manganese-Zinc (MnZn) and Nickel-Zinc (Ni—Zn) ferrites are the material of choice for power magnetic applications within the 100 KHz to 10 MHz operating frequency range due primarily to their moderate saturation flux densities (0.2-0.53 T) and higher resistivities, which limits the eddy current losses. The addition of Zn increases the saturation moment, which allows for higher flux densities. However, the non-magnetic nature of zinc lowers the curie temperature due to weakening of the total magnetic interactions. Currently, these ferrites are manufactured via classical powder metallurgy techniques. This involves milling of the individual powders (Manganese Oxide, Nickel Oxide, ZnO and Fe₂O₃) followed by calcination treatment. Subsequently, the powders are milled again with the addition of binders, pressed and sintered to obtain the final product in the desired shape.

The maximum operating power of a power electronic circuit is limited by the breakdown voltage of the semiconductor, beyond which the conductivity of the semiconductor increases exponentially. The breakdown voltage of any semiconductor is directly proportional to the band gap of the semiconductor. Therefore, realization of high operating powers at increased frequencies requires the development of semiconductors with larger bandgaps than those that are currently used.

Ultrawide bandgap semiconductors (UWBG) are semiconductors with bandgaps 3.9 eV<=E_{g}. Examples include AlGaN/GaN, diamond, Ga₂O₃ and cubic BN. UWBG semiconductor devices theoretically can have much higher figure of merits (FOM) for device performances due the non-linear variation of FOMs, such as the Baliga FOM and Johnson FOM with critical electric field. As a result, successful realization of UWBG semiconductor devices can lead to the significantly higher performance and higher operating powers.

Successful implementation of UWBG semiconductors in power electronics will also need the development of soft magnetic materials which can operate at higher operating powers. At lower frequencies, metal amorphous nanocomposite (MANC) alloys or nanocrystalline alloys are the material of choice due their high saturation flux densities. In comparison, ferrites, which are used at frequencies beyond 100 Khz, suffer from low saturation flux densities. This limits the operating power of the power electronic circuit. Increasing the operating power with current ferrites will result in the need for larger cores than would otherwise be required for nanocrystalline alloys, or, alternatively, for higher power density, it will require the core to reach closer to saturation in each cycle, increasing the dynamic magnetic losses significantly.

### SUMMARY OF THE INVENTION

In one embodiment, a method of making a nanocomposite material is provided that includes obtaining a base ferrite material, and reducing a material including the base ferrite material to selectively precipitate out ferromagnetic metal ions to produce a reduced material, wherein the reduced material includes a ferrite matrix having a plurality of ferrite grains and a plurality of metal nanoparticles on a surface of and/or embedded within each of the ferrite grains.

In another embodiment, a nanocomposite material is provided that includes a base ferrite material having a ferrite matrix including a plurality of ferrite grains, and a plurality of metal nanoparticles provided on a surface of and/or embedded within each of the ferrite grains.

In still another embodiment, a method of making a nanocomposite passive component for electromagnetic applications is provided that includes obtaining a base ferrite material, forming a material including the base ferrite material to into a passive component, and reducing the passive component to selectively precipitate out ferromagnetic metal ions and produce the nanocomposite passive component, wherein the nanocomposite passive component includes a ferrite matrix having a plurality of ferrite grains and a plurality of metal nanoparticles on a surface of and/or embedded within each of the ferrite grains.

In yet another embodiment, a nanocomposite passive component for electromagnetic applications is provided that includes a base ferrite material having a ferrite matrix including a plurality of ferrite grains, and a plurality of metal nanoparticles provided on a surface of and/or embedded within each of the ferrite grains.

In still another embodiment, a method of making a nanocomposite material is provided that includes obtaining a base ferrite material, creating a mixture including the base ferrite material and a plurality of metal nanoparticles, and thermally processing the mixture to produce the nanocomposite material, wherein the nanocomposite material includes a ferrite matrix having a plurality of ferrite grains and the plurality of metal nanoparticles on a surface of and/or embedded within each of the ferrite grains.

In another embodiment, a method of making a nanocomposite passive component for electromagnetic applications includes obtaining a base ferrite material, creating a mixture including the base ferrite material and a plurality of metal nanoparticles, forming the mixture into a passive component, and thermally processing the passive component to produce the nanocomposite passive component, wherein the nanocomposite passive component includes a ferrite matrix having a plurality of ferrite grains and a the plurality of metal nanoparticles on a surface of and/or embedded within each of the ferrite grains.

### BRIEF DESCRIPTION OF THE DRAWINGS

A full understanding of the invention can be gained from the following description of the preferred embodiments when read in conjunction with the accompanying drawings in which:

FIG. 1 is a flowchart showing a method of making a nanocomposite material according to an exemplary embodiment of the disclosed concept;

FIG. 2 provides X-ray diffraction plots for an exemplary Ni—Zn phase pure ferrite powder according to an exemplary embodiment of the disclosed concept;

FIG. 3 shows M-H loops of an exemplary base ferrite and nanocomposite according to an exemplary embodiment of the disclosed concept;

FIG. 4 is an SEM image in the BSE mode of an exemplary nanocomposite material according to an exemplary embodiment of the disclosed concept;

FIG. 5 is a high-resolution TEM image of an exemplary nanocomposite material according to an exemplary embodiment of the disclosed concept;

FIGS. 6 and 7 are a BF-STEM image and the corresponding maps, respectively, of an exemplary nanocomposite material according to an exemplary embodiment of the disclosed concept;

FIG. 8 is a flowchart showing a method of making a toroidal magnetic core comprising a nanocomposite material according to an exemplary embodiment of the disclosed concept;

FIG. 9 is an X-ray diffractogram of an exemplary core produced according to the method of FIG. 8 (at both 800 and 900° C.);

FIG. 10A is an SEM image in the BSE mode of an exemplary core reduced at 800° C.;

FIG. 10B is an SEM image in the BSE mode of an exemplary core reduced at 900° C.;

FIG. 11 shows M-H loops of an exemplary base ferrite and an exemplary nanocomposite core according to an alternative exemplary embodiment of the disclosed concept;

FIG. 12 is a plot showing the relative permeability of the exemplary base ferrite and the exemplary nanocomposite core according to an alternative exemplary embodiment of the disclosed concept;

FIG. 13 is an X-ray diffractogram of a base ferrite core and the subsequent nanocomposites which have been produced by reduction of the ferrite core at 900 C for 1 hr (NC1) and 3 hrs (NC2) according to exemplary embodiments of the method of FIG. 8;

FIGS. 14 and 15 are SEM images in the BSE mode, captured from NC1 and NC2, respectively, which show metallic precipitation upon reduction primarily at the grain boundaries;

FIG. 16 is a plot that shows M-H loops for the base ferrite, NC1 and NC2;

FIG. 17. provides flowcharts for three different alternative embodiments of the disclosed concept; and

FIG. 18 shows a number of different exemplary ferrite matrix metal combinations that can be synthesized using the method of the disclosed concept.

### DETAILED DESCRIPTION OF THE INVENTION:

As used herein, the singular form of “a”, “an”, and “the” include plural references unless the context clearly dictates otherwise.

As used herein, the statement that two or more parts or components are “coupled” shall mean that the parts are joined or operate together either directly or indirectly, i.e., through one or more intermediate parts or components, so long as a link occurs.

As used herein, “directly coupled” means that two elements are directly in contact with each other.

As used herein, the term “nanocomposite material” shall mean a solid material where one of the phases has at least one dimension of less than 1000 nanometers (nm) or less (in particular embodiments, the nanocomposite material may be further limited to solid materials where one of the phases has at least one dimension of less than 250 nm, 200 nm, or 100 nm).

As used herein, the term “nanoparticle” shall mean an object that behaves as a whole unit with respect to its transport and properties having a size (e.g., diameter or width) less than 1000 nm (in particular embodiments, nanoparticles may be further limited to objects having a size of less than 250 nm, 200 nm, or 100 nm).

As used hereon, the term “approximately” shall mean ±10% of a given value.

As used herein, the term “number” shall mean one or an integer greater than one (i.e., a plurality).

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The disclosed concept will now be described, for purposes of explanation, in connection with numerous specific details in order to provide a thorough understanding of the subject invention. It will be evident, however, that the disclosed concept can be practiced without these specific details without departing from the spirit and scope of the disclosed concept.

The disclosed concept, as described herein, provides metal/oxide nanocomposites as a solution to overcome low saturation flux densities in current SMMs by combining the properties of a metal (with high saturation flux density) dispersed within a ferrite matrix (with high resistivities). This allows for higher operating powers without saturating the material, thereby keeping the hysteretic and eddy current losses low. The methods as described herein for producing metal/oxide nanocomposites are advantageous as they may be readily scaled for commercial production. As described herein, the methods of the disclosed concept use a combination of thermal and mechanical processing techniques to produce nanocomposite materials and, subsequently, to produce magnetic cores or other passive components from the metal/oxide nanocomposites for a wide variety of electromagnetic applications.

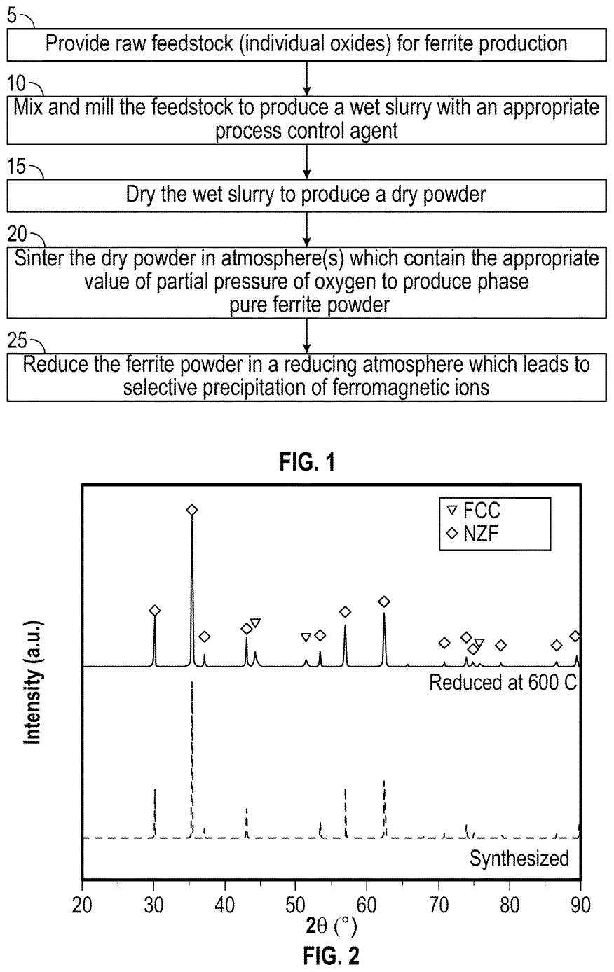

FIG. 1 is a flowchart showing a method of making a nanocomposite material according to an exemplary embodiment of the disclosed concept. The method begins at step 5, wherein a raw feedstock comprising a number of individual oxides is provided for ferrite production. In the exemplary embodiment. the ferrite that is to be produced is Ni—Zn ferrite (with the individual oxides being Fe₂O₃, NiO and ZnO, although it will be understood that other ferrites, such as, without limitation, Mn—Zn ferrite (with the individual oxides being Fe₂O₃, NiO and MnO₂) may also be produced and utilized in the nanocomposite production method of the disclosed concept. Next, at step 10, the feedstock is mixed and milled with an appropriate process control agent to produce a wet slurry. In the non-limiting exemplary embodiment, the feedstock is milled using stainless steel media at 350 rpm for 2 hours with isopropyl alcohol (IPA) being the process control agent. Then, at step 15, the wet slurry is dried to produce a dry powder. Then, at step 20, the dry powder is sintered in atmosphere(s) which contain the appropriate value of partial pressure of oxygen to produce phase pure ferrite powder. In the non-limiting exemplary embodiment, the dry powder is sintered in an alumina crucible at at 1100° C. in atmospheric conditions wherein Po₂=0.21 atm to produce a phase pure ferrite powder. Next, at step 25, the phase pure ferrite powder is reduced in a reducing atmosphere (or, alternatively, an inert atmosphere which may not include H₂) which leads to selective precipitation of ferromagnetic ions to produce a reduced ferrite powder comprising a nanocomposite material. The atmosphere in general is one where the metallic phase is thermodynamically stable. In the non-limiting exemplary embodiment, the reducing atmosphere is a flowing 5% H₂/95% N₂ atmosphere with a flow rate of 50 sccm at 600° C. and the phase pure ferrite powder is reduced for 1 hr. In addition, in one particular exemplary embodiment, following the reducing, the material may optionally also be further heated and cooled (with heating and cooling rates being maintained at 4° C./min) in flowing N₂ atmosphere with a flow rate of 100 sccm. As a further alternative, the reducing atmosphere may be applied on the cooling of the sintering of step 20. Thus, the method of FIG. 1 results in the production of a metal/oxide nanocomposite wherein metal ions are precipitated and combined with the ferrite matrix as described elsewhere herein. In particular, the nanocomposite material will include a plurality of ferrite grains that form a ferrite matrix with metal nanoparticles (from the reduction reaction) being provided on the surface of and/or embedded within each of the ferrite grains. In the exemplary embodiment in which the ferrite is Ni—Zn ferrite, the reduction process at step 25 will result in nickel nanoparticles being precipitated and being on the surface of and/or embedded within the Ni—Zn ferrite grains.

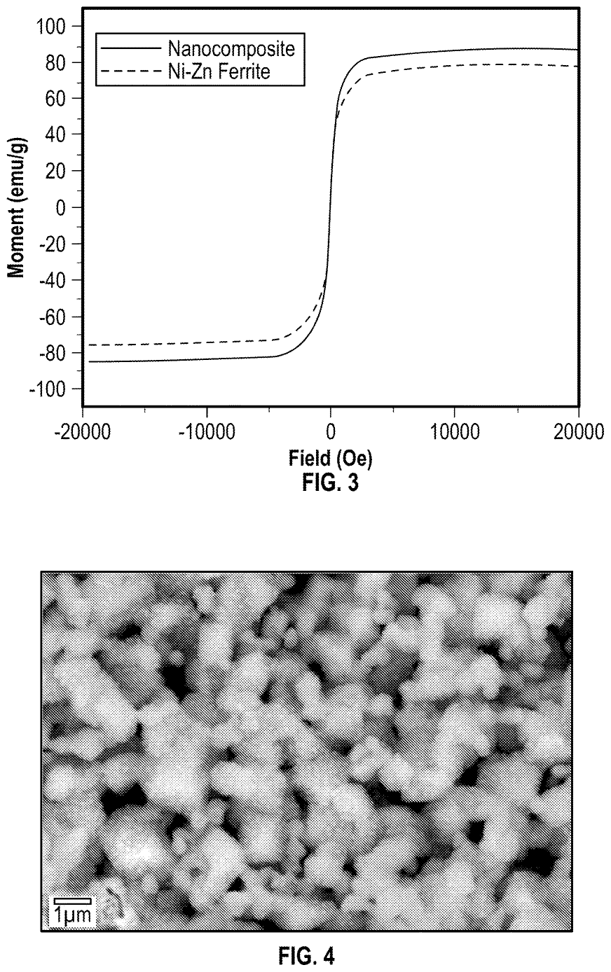

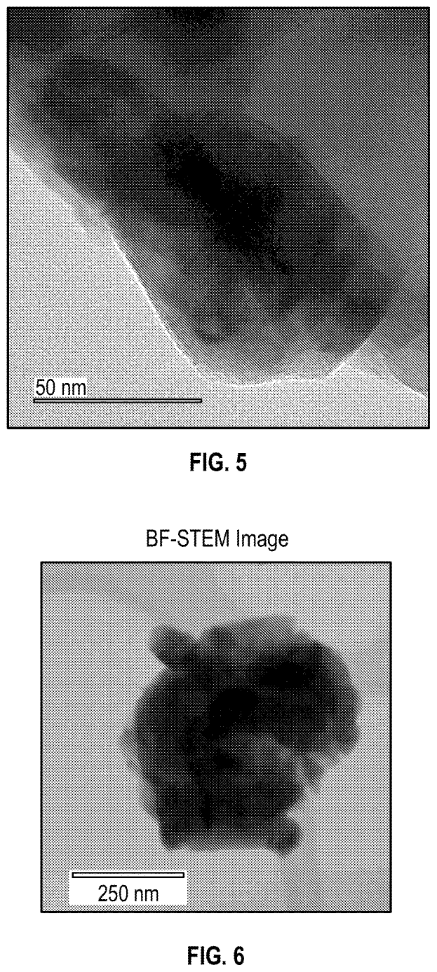

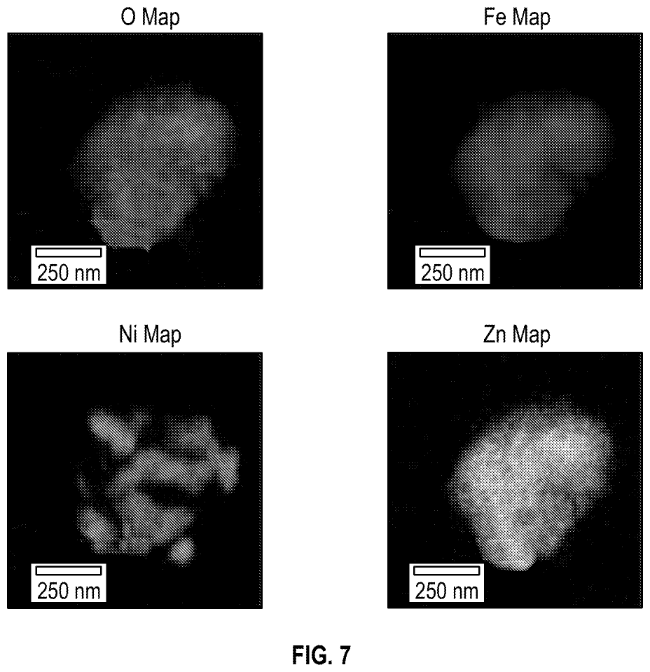

FIG. 2 provides X-ray diffraction plots for an exemplary Ni—Zn phase pure ferrite powder synthesized at steps 5-20, and an exemplary reduced ferrite powder (nanocomposite) produced at step 25 of the method of FIG. 1. In addition, FIG. 3 shows M-H loops of the base ferrite and nanocomposite, showing an increase in saturation magnetization for the nanocomposite. Precipitation of a phase with a face sintered cubic structure (FCC) can be observed upon reduction. Moreover, no phase separation of the base ferrite is observed, indicating the preservation of the ferrite matrix. FIG. 4 is an SEM image in the BSE mode of the exemplary nanocomposite material, which shows small precipitates on the surface of the ferrite grains. FIG. 5 is a high-resolution TEM image of the exemplary nanocomposite material, which shows a distinct interface between the precipitate and the metallic precipitate. This image also shows that the precipitate is on the order few nanometers in length. Due to the length scale of the particle being small, STEM-EDS mapping was carried out to understand the chemical composition of the material. A BF-STEM image and the corresponding maps are shown in FIGS. 6 and 7, respectively. These images show that the precipitates are rich in Ni primarily. Furthermore, M-H loops measured using vibrating sample magnetometry showed an increase in saturation magnetization for the sample reduced in comparison to the standard Ni—Zn ferrite. These precipitates provide the required increase in saturation magnetization needed to realize the switch to UWBG power electronic devices.

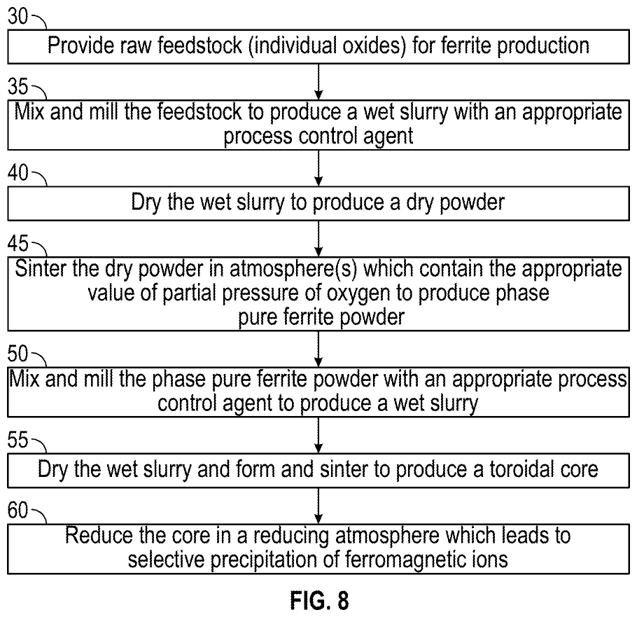

FIG. 8 is a flowchart showing a method of making a toroidal magnetic core comprising a nanocomposite material according to another exemplary embodiment of the disclosed concept. The method begins at step 30, wherein a raw feedstock comprising a number of individual oxides is provided for ferrite production. In the exemplary embodiment, the ferrite that is to be produced is Ni—Zn ferrite (with the individual oxides being Fe₂O₃, NiO and ZnO), although it will be understood that other ferrites, such as, without limitation, Mn—Zn ferrite (with the individual oxides being Fe₂O₃, NiO and MnO₂) may also be used. Next, at step 35, the feedstock is mixed and milled with an appropriate process control agent to produce a wet slurry. In the exemplary embodiment, the feedstock is milled using stainless steel media at 350 rpm for 2 hours with IPA as the process control agent. Then, at step 40, the wet slurry is dried to produce a dry powder. At step 45, the dry powder is sintered in atmosphere(s) which contain the appropriate value of partial pressure of oxygen to produce phase pure ferrite powder. In a non-limiting exemplary embodiment, the dry powder is sintered in an alumina crucible at 1100° C. in atmospheric conditions wherein Po₂=0.21 atm to produce a phase pure ferrite powder. Next, at step 50, the feedstock comprising the phase pure ferrite powder is mixed and milled with an appropriate process control agent to produce a wet slurry. In a non-limiting exemplary embodiment, the phase pure ferrite powder is mixed and milled using stainless steel media at 350 rpm for 0.5 hours with IPA as the process control agent. Next, at step 55, the wet slurry including the milled phase pure ferrite powder is dried, formed (e.g., pressed) into a toroidal core, and subsequently sintered in appropriate atmospheric conditions. In the non-limiting exemplary embodiment, the toroidal core is sintered at 1250° C. in atmospheric conditions wherein Po₂=0.21 atm. Then, at step 60, the sintered core is reduced in a reducing atmosphere (or an inert atmosphere which may not include H₂) which leads to selective precipitation of ferromagnetic ions. In one non-limiting exemplary embodiment, the core is reduced in a flowing 5% H₂/95% N₂ atmosphere with a flow rate of 50 sccm at 800° C. for 1 hour. In another non-limiting exemplary embodiment, the core is reduced in a flowing 5% H₂/95% N₂ atmosphere with a flow rate of 50 sccm at 900° C. for 1 hour. Step 60 results in the production of a core comprising a reduced ferrite powder including a nanocomposite material wherein metal nanoparticles (for example, Ni nanoparticles in the exemplary embodiment) are precipitated out and provided on and/or embedded within the ferrite grains. In addition, in one particular non-limiting exemplary embodiment, the reducing step as described may be preceded by and followed by heating in a flowing N₂ atmosphere at an appropriate temperature, such as 800 or 900° C. The method of FIG. 8 thus produces a toroidal core that may be used for various electromagnetic applications, such as, without limitation, power electronics applications and microwave applications, that comprises a nanocomposite material that includes ferrite grains and metal nanoparticles provided on or embedded within the ferrite grains to provide improved magnetic performance of the toroidal core.

In the exemplary embodiment shown in FIG. 8, the reduction (step 60) is performed after the sintering (step 55), i.e., the core is sintered and then reduced afterward to induce precipitation. Other exemplary embodiments may include either introducing a reduction gas during the sintering stage (e.g., as part of the cooling) to induce precipitation, which would make it a single step process.

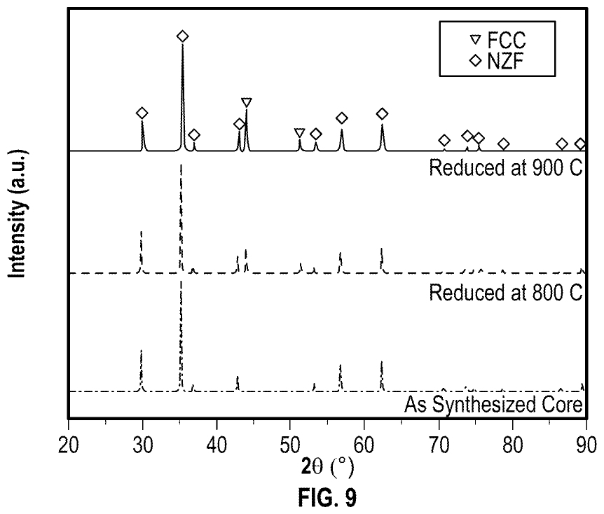

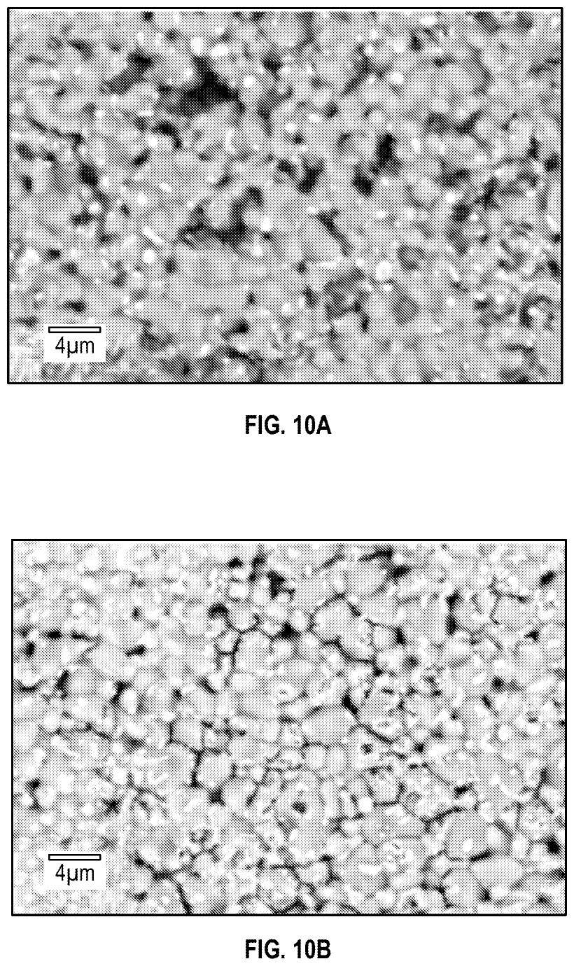

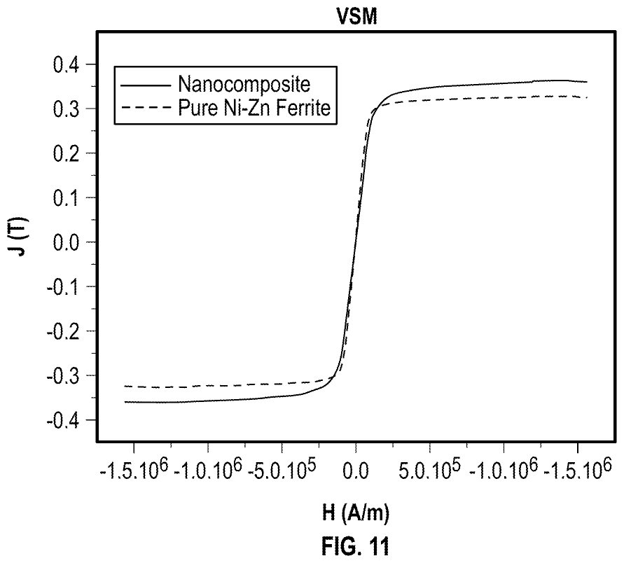

FIG. 9 is an X-ray diffractogram of an exemplary core produced according to the method of FIG. 8 (at both 800 and 900° C.), which confirms the precipitation of metal particles on the surface of the grains of the core. FIG. 10A is an SEM image in the BSE mode of an exemplary core reduced at 800° C. that shows the precipitates on the surface of the core, and FIG. 10B is an SEM image in the BSE mode of an exemplary core reduced at 900° C. that shows the precipitates on the surface of the core.

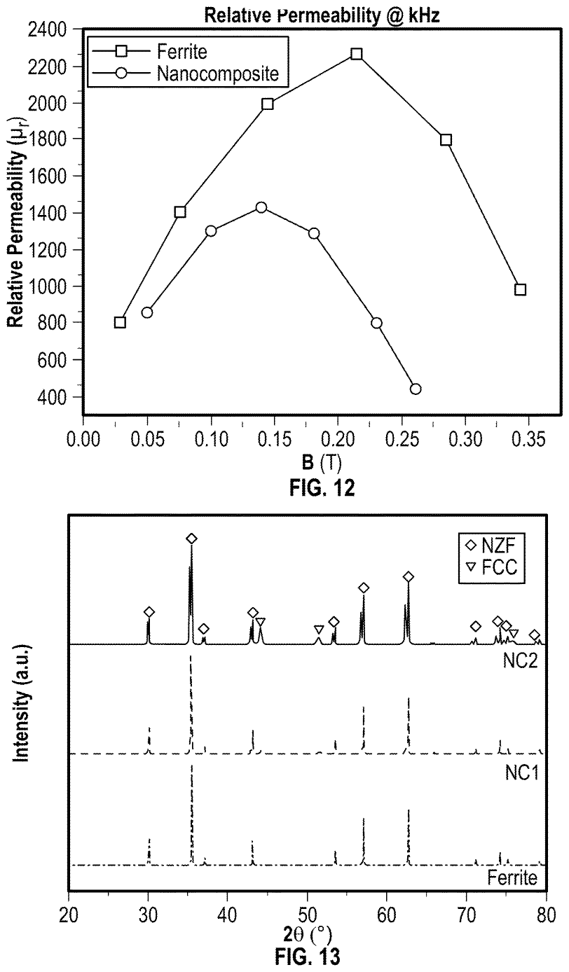

FIG. 11 shows M-H loops of an exemplary base ferrite and an exemplary nanocomposite core of this embodiment, showing an increase in saturation magnetization for the nanocomposite. FIG. 12 is a plot showing the relative permeability of the exemplary base ferrite and the exemplary nanocomposite core of this embodiment at 10 kHz, with the nanocomposite core having reduced permeability.

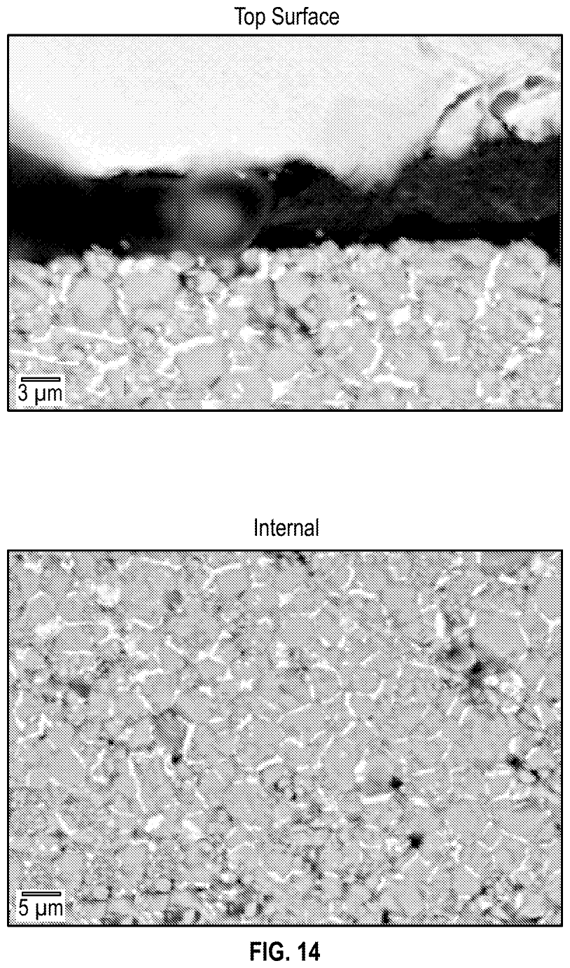

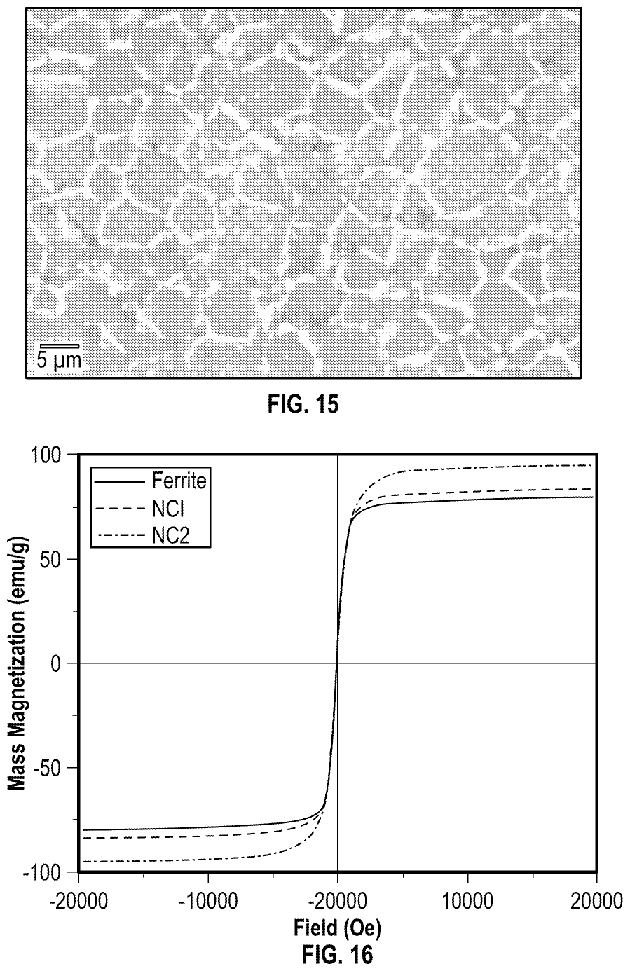

FIG. 13 is an X-ray diffractogram of a base ferrite core and the subsequent nanocomposites which have been produced by reduction of the ferrite core at 900 C for 1 hr (NC1) and 3 hrs (NC2) according to exemplary embodiments of the method of FIG. 8. FIGS. 14 and 15 are SEM images in the BSE mode, captured from NC1 and NC2, respectively, which show metallic precipitation upon reduction primarily at the grain boundaries. FIG. 16 is a plot that shows M-H loops for the base ferrite, NC1 and NC2, which shows the increased saturation magnetization that was observed for captured from NC1.

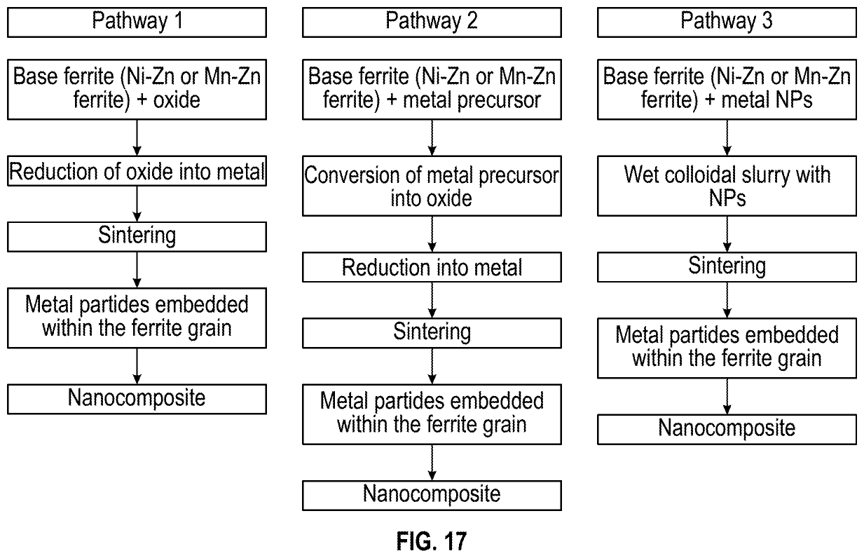

FIG. 17 provides flowcharts for three different alternative embodiments of the disclosed concept, labeled Pathway 1, Pathway 2 and Pathway 3. Each of these Pathways is described below and is a variation of the methods shown in FIGS. 1 and 8, wherein and oxide (Pathway 1), and metal precursor (Pathway 2), or metal nanoparticles (Pathway 3) are used in the nanocomposite material production,

In Pathway 1, a metal oxide precursor, such as, without limitation, NiO, is added to the base ferrite (which is a phase pure base ferrite in the exemplary embodiment) that is produced as described herein. Thereafter, the metal oxide is reduced into a metal (e.g., Ni) in a reducing atmosphere as described herein, which leads to selective precipitation of ferromagnetic ions. Then, the reduced material is sintered in dry air, with the result being metal nanoparticles (e.g., Ni nanoparticles) are embedded within or provided on the ferrite grains of the base ferrite matrix to produce a nanocomposite material according to the disclosed concept.

In Pathway 2, a non-oxide metal precursor, such as Nickel Nitrate or another nitrate, is added to the base ferrite (which is a phase pure base ferrite in the exemplary embodiment) that is produced as described herein. Then the metal precursor is converted into an oxide (e.g., NiO), such as by using a calcination process. Thereafter, the oxide is reduced into a metal (e.g., Ni) in a reducing atmosphere as described herein, which leads to selective precipitation of ferromagnetic ions. Then, the reduced material is sintered in dry air, with the result being metal nanoparticles (e.g., Ni nanoparticles) embedded within or provided on the ferrite grains of the base ferrite matrix to produce a nanocomposite material according to the disclosed concept.

In Pathway 3, metal nanoparticles, such as Ni nanoparticles, are added to the base ferrite (which is a phase pure base ferrite in the exemplary embodiment) that is produced as described herein. Then, a wet colloidal slurry of the base ferrite and the metal nanoparticles is created. Thereafter, the wet slurry is dried and sintered in dry air, with the result being metal nanoparticles (e.g., Ni nanoparticles) embedded within or provided on the ferrite grains of the base ferrite matrix to produce a nanocomposite material according to the disclosed concept.

In addition, as just described, the sintering is performed in dry air. Alternatively, the sintering may be performed in an atmosphere including an inert gas or an atmosphere with low levels of hydrogen or a reduction gas to prevent oxidation of the metallic particles.

In any of these alternative pathways, the nanocomposite material may subsequently be formed into a passive component, such as a toroidal core. The passive component may also then be further thermally processed using appropriate thermal processing technique to produce the final nanocomposite passive component.

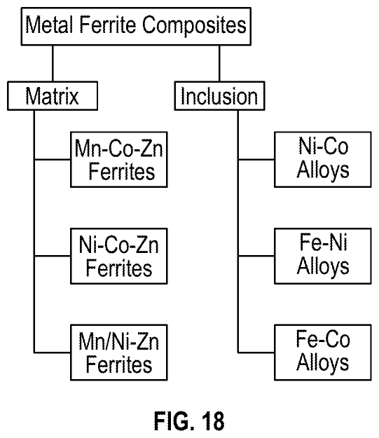

FIG. 18 shows a number of additional non-limiting exemplary ferrite matrix metal nanocomposite combinations that can be synthesized using the method of the disclosed concept. For example, the nanocomposite combination may include a base ferrite matrix comprising an Mn—Co—Zn ferrite, a Ni—Co—Zn ferrite, a Mn/Ni—Zn ferrite, or a Ni—Co—Mn—Zn ferrite. These ferrites are meant to be exemplary only, and it will be understood that a wide range of other cations and elements can be added/utilized as well to optimize properties. In addition, the nanocomposite may include, without limitation, nanoparticles comprising Ni—Co alloy nanoparticles, Fe—Ni alloy nanoparticles, Fe—Co alloys, or Fe—Ni—Co alloys. These nanoparticles and alloys are meant to be exemplary only, and it will be understood that a wide range of other nanoparticles and alloys can be added/utilized as well to optimize properties. In addition, such exemplary nanoparticles may be produced using Pathway 2 by way of constituent oxides of the alloys, or by Pathway 3 by way of the direct addition of nanoparticles of the alloys.

More specifically, ferrites typically have the form of AB₂O₄. In one non-limiting exemplary embodiment, the disclosed concept reduces a (NiZn)Fe₂O₄ type ferrite to specifically precipitate out nickel. The composition of the ferrite can, however, be changed to add Co to it, which will make it a (NiCoZn)Fe₂O₄ ferrite. Upon reduction, this will precipitate out Ni—Co alloys instead of Ni. Thus, by tailoring the cation chemistry to add, for example, Co, Fe or Ni, the reduction product can be changed. It will be understood that this example is not meant to be limiting and that a wide range of other elements (other than Co) can also be utilized. In general, the composition of the ferrite chemistry can be modified to ensure the precipitation of the appropriate phase to optimize properties.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of disclosed concept which is to be given the full breadth of the claims appended and any and all equivalents thereof.

What is claimed is:

1. A method of making a nanocomposite material, comprising:
obtaining a base ferrite material; and
reducing a material including the base ferrite material to selectively precipitate out ferromagnetic metal ions to produce a reduced material, wherein the reduced material includes a ferrite matrix having a plurality of ferrite grains and a plurality of metal nanoparticles on a surface of and/or embedded within each of the ferrite grains.

2. The method according to claim 1, wherein the base ferrite material is a phase pure ferrite material.

3. The method according to claim 2, further comprising: (i) providing and mixing a raw feedstock including individual oxides, (ii) milling the mixed raw feedstock with a process control agent to produce a wet slurry, (iii) drying the wet slurry to produce a dry powder, and (iv) thermally processing the dry powder to produce the phase pure ferrite material.

4. The method according to claim 3, wherein the process control agent is isopropyl alcohol.

5. The method according to claim 1, wherein the base ferrite material is a Ni—Zn ferrite and wherein the metal nanoparticles are Ni nanoparticles.

6. The method according to claim 1, wherein the base ferrite material is an Mn—Zn ferrite and wherein the metal nanoparticles are Fe nanoparticles.

7. The method according to claim 1, wherein the reducing atmosphere is a flowing H₂/N₂ atmosphere.

8. The method according to claim 7, wherein the flowing H₂/N₂ atmosphere is a flowing 5% H₂/95% N₂ atmosphere.

9. The method according to claim 1, further comprising:
adding an oxide to the base ferrite material to produce an oxide/ferrite mixture; and
wherein the material including the base ferrite material includes the oxide/ferrite mixture and the reducing comprises reducing the oxide/ferrite mixture to selectively precipitate out the ferromagnetic metal ions to produce the reduced material.

10. The method according to claim 9, wherein the oxide is a metal oxide.

11. The method according to claim 1, further comprising:
adding a non-oxide metal precursor to the base ferrite material; and
converting the non-oxide metal precursor to an oxide to produce an oxide/ferrite mixture;
wherein the material including the base ferrite material includes the oxide/ferrite mixture and the reducing comprises reducing the oxide/ferrite mixture to selectively precipitate out the ferromagnetic metal ions to produce the reduced material.

12. The method according to claim 11, wherein the non-oxide metal precursor comprises Nickel Nitrate.

13.-14. (canceled)

15. A method of making a nanocomposite passive component for electromagnetic applications, comprising:
obtaining a base ferrite material;
forming a material including the base ferrite material into a passive component; and
reducing the passive component to selectively precipitate out ferromagnetic metal ions and produce the nanocomposite passive component, wherein the nanocomposite passive component includes a ferrite matrix having a plurality of ferrite grains and a plurality of metal nanoparticles on a surface of and/or embedded within each of the ferrite grains.

16. The method according to claim 15, wherein the base ferrite material is a phase pure ferrite material.

17. The method according to claim 16, further comprising: (i) providing and mixing a raw feedstock including individual oxides, (ii) milling the mixed raw feedstock with a process control agent to produce a wet slurry, (iii) drying the wet slurry to produce a dry powder, and (iv) thermally processing the dry powder to produce the phase pure ferrite material.

18. The method according to claim 17, wherein the process control agent is isopropyl alcohol.

19. The method according to claim 15, wherein the base ferrite material is a Ni—Zn ferrite and wherein the metal nanoparticles are Ni nanoparticles.

20. The method according to claim 15, wherein the base ferrite material is an Mn—Zn ferrite and wherein the metal nanoparticles are Fe nanoparticles.

21. The method according to claim 18, wherein the reducing is performed in an H₂/N₂ atmosphere.

22. The method according to claim 21, wherein the H₂/N₂ atmosphere is a 5% H₂/95% N₂ atmosphere.

23. The method according to claim 15, wherein the nanocomposite passive component is a toroidal core.

24. The method according to claim 15, further comprising:
adding an oxide to the base ferrite material to produce an oxide/ferrite mixture, wherein the material including the base ferrite material includes the oxide/precursor mixture.

25. The method according to claim 24, wherein the reducing includes reducing the oxide to a metal.

26. The method according to claim 15, further comprising:
adding a non-oxide metal precursor to the base ferrite material; and
converting the non-oxide metal precursor to an oxide to produce an oxide/ferrite mixture, wherein the material including the base ferrite material includes the oxide/ferrite mixture.

27. The method according to claim 26, wherein the reducing includes reducing the oxide to a metal.

28. The method according to claim 26, wherein the non-oxide metal precursor comprises Nickel Nitrate.

29.-35. (canceled)

36. The method according to claim 1, wherein the base ferrite material comprises a Mn—Co—Zn ferrite, a Ni—Co—Zn ferrite, a Mn—Ni—Zn ferrite, or a Ni—Mn—Co—Zn ferrite, and wherein the metal nanoparticles comprise Ni—Co alloy nanoparticles, Fe—Ni alloy nanoparticles, Fe—Co alloy nanoparticles, or Fe—Co—Ni alloy nanoparticles.

37. The method according to claim 15, wherein the base ferrite material comprises a Mn—Co—Zn ferrite, a Ni—Co—Zn ferrite, a Mn—Ni—Zn ferrite, or a Ni—Mn—Co—Zn ferrite, and wherein the metal nanoparticles comprise Ni—Co alloy nanoparticles, Fe—Ni alloy nanoparticles, Fe—Co alloy nanoparticles, or Fe—Co—Ni alloy nanoparticles.

38.-39. (canceled)

40. The method according to claim 1, wherein the reducing is performed during a sintering step or during a cooling step.

41. The method according to claim 15, wherein the reducing is performed during a sintering step or during a cooling step.

42. The method according to claim 1, further comprising performing a sintering step following the reducing.

43. The method according to claim 42, wherein the sintering is performed in dry air.

44. The method according to claim 42, wherein the sintering is performed in an atmosphere that includes an inert gas, hydrogen or a reduction gas.

45. The method according to claim 15, further comprising performing a sintering step following the reducing.

46. The method according to claim 45, wherein the sintering is performed in dry air.

47. The method according to claim 45, wherein the sintering is performed in an atmosphere that includes an inert gas, hydrogen or a reduction gas.

48.-51. (canceled)
